(19) United States
(12) Patent Application Publication
(10) Pub. No.: US 2026/0081046 A1
(43) Pub. Date: Mar. 19, 2026

(54) TRACE OXYGEN SODIUM LEAK DETECTION IN NUCLEAR REACTOR ENCLOSURE

(71) Applicant: TerraPower, LLC, Bellevue, WA (US)

(72) Inventors: Stephen Moore, Kirkland, WA (US); Christopher M. Regan, Seattle, WA (US)

(21) Appl. No.: 19/272,780

(22) Filed: Jul. 17, 2025

Related U.S. Application Data
(60) Provisional application No. 63/695,501, filed on Sep. 17, 2024.

(51) Int. Cl. G21C 17/00; G01M 3/22; G01M 3/28; G08B 21/18; G21C 1/02; G21C 15/28

(52) U.S. Cl. CPC G21C 17/002; G01M 3/222; G01M 3/2846; G08B 21/182; G21C 1/028; G21C 15/28

(57) ABSTRACT

A sodium leak detection system for a nuclear reactor vessel includes a recirculation loop having an inlet and an outlet in communication with the annular space between the nuclear reactor vessel and the guard vessel. The recirculation loop and the annulus are filled with an inert gas, such as argon. The inert gas is doped with a known trace quantity of oxygen, typically in the single-digit ppm range up to about 1%. A recirculator forces the inert gas and oxygen to mix and flow throughout the annulus. The recirculation loop further includes a trace oxygen sensor that determines the concentration of oxygen in the inert gas. Because sodium reacts with oxygen, the trace oxygen sensor is monitored for a reduction in the oxygen level, which indicates a sodium leak into the annulus.

### CROSS REFERENCE

The present application claim benefit of priority to U.S. Provisional Patent Application No. 63/695,501, filed Sep. 17, 2024, titled “TRACE OXYGEN SODIUM LEAK DETECTION IN NUCLEAR REACTOR ENCLOSURE,” the entire contents of which is hereby incorporated by reference.

### GOVERNMENT LICENSE RIGHTS

This invention was made with government support under DOE Cooperative Agreement No. DE-NE0009054 awarded by the U.S. Department of Energy. The government has certain rights in the invention.

### FIELD OF THE DISCLOSURE

This disclosure is directed to a system and method for detecting sodium leaks.

### BACKGROUND

Primary coolant leaks in sodium-cooled fast reactors (SFRs) represent a significant safety and operational concern. These reactors, which use liquid sodium as a primary coolant, are designed for high-efficiency electricity generation and efficient fuel utilization. However, the unique properties of sodium introduce specific challenges when it leaks from the reactor vessel. For example, sodium can react vigorously with water and air. In the presence of air, it forms sodium oxide and sodium hydroxide, releasing heat. When it contacts water, it produces hydrogen gas and sodium hydroxide, which can lead to explosive reactions. Furthermore, sodium has excellent thermal conductivity, making it effective in transferring heat from the reactor core. However, this also means that any leak could rapidly spread thermal energy to unintended areas.

Within a nuclear reactor vessel, small leaks can develop at welds, flanges, or through material degradation over time. These may initially go undetected but can grow and lead to significant safety concerns. Even small leaks pose hazardous conditions. Sodium reacts exothermally with oxygen, which cause a fire hazard if leaking sodium is allowed to contact air. Sodium's reaction with water produces hydrogen gas, which is highly explosive in the presence of an ignition source, which could further complicate containment efforts and also produces sodium hydroxide which is a corrosive media to many stainless steels.

Additionally, the primary coolant in SFRs becomes radioactive over time due to neutron activation, particularly forming isotopes such as ²⁴Na. A leak from the reactor vessel can lead to the spread of radioactive sodium within the containment area, or in severe cases, beyond it. A sodium leak can further cause localized heating of structural materials, potentially leading to further structural damage or comprise of the containment boundary.

Detecting leakage of the reactor vessel (RV) is a difficult task, and an enclosure surrounding the reactor vessel is a large volume, and typical instrumentation used for detecting sodium leaking can only detect leakage in a limited area. For instance, continuity type sodium leak detectors placed in the bottom of the RV enclosure can only detect leakage if liquid sodium makes direct contact with the sensor. While this may be suitable for large leaks (e.g., gallons or more of leaking sodium within a short time period), these sensors are not suitable for smaller leaks which may take a long time, or an indefinite time, to reach these continuity detectors.

It would be an improvement in the art if sodium leaks could be detected within the RV-GV annulus, especially small leaks, without requiring continuity detectors to be wetted by the leaking sodium in order to detect a leak. These, and other advantages, will become readily apparent to those of skill in the art by reference to the following description and figures.

### SUMMARY

According to some embodiments, a sodium leak detection system for a nuclear reactor includes a recirculation loop in fluid communication with an enclosure surrounding the reactor vessel, such as a guard vessel (GV) which annularly surrounds the reactor vessel (RV), and shall herein be referred to herein as a reactor vessel-guard vessel annulus (RV-GV annulus) or just “annulus.” The sodium leak detection system further includes an inert gas within the recirculation loop and RV-GV annulus; a recirculator in communication with the recirculation loop and configured to flow the inert gas through the recirculation loop and RV-GV annulus; a source of oxygen configured to introduce a predetermined amount of oxygen into the inert gas; and a trace oxygen sensor disposed to detect an oxygen concentration within the inert gas.

The sodium leak detection system may further include a radiation detector in communication with the recirculation loop which may be configured to determine a radioactivity level of the inert gas within the recirculation loop. An increase in radiation of the inert gas may indicate contact with activated sodium that has leaked.

The recirculator may be one or more of a blower, fan, pump, or compressor, or a combination. More than one recirculator may be provided to encourage the inert gas doped with oxygen to flow throughout the closed volume.

The RV-GV annulus is a space between a reactor vessel and a guard vessel and the reactor vessel may include an inventory of liquid sodium. A cover gas area is inside the reactor vessel and above the inventory of liquid sodium, and wherein a first pressure in the cover gas area is greater than a second pressure within the RV-GV annulus. This causes any leaks from the cover gas area to flow from the reactor vessel into the RV-GV annulus.

In some cases, the recirculation loop comprises one or more nozzles for injecting the inert gas into the RV-GV annulus. The nozzles may be spaced vertically within the RV-GV annulus, may be spaced circumferentially about the RV-GV annulus, and may be oriented to cause gas to flow around the circumference of the RV-GV annulus.

According to some embodiments, a method of detecting a sodium leak includes the steps of introducing an inert gas into a closed volume; doping the inert gas with a known quantity of oxygen; causing the inert gas and oxygen to flow through the closed volume; measuring an oxygen concentration in the inert gas; determining, with a trace oxygen sensor, that the oxygen concentration has reduced; and determining, based at least in part on the reduced oxygen concentration, that a sodium leak has occurred into the volume.

The method may further include the step of measuring a radioactivity of the inert gas and determining that a sodium leak has occurred based at least in part on an increased radioactivity of the inert gas.

The known quantity of oxygen may be less than 15 parts per million (ppm), and may be 10 ppm, 5 ppm, 1 ppm, or some other quantity. Similarly, the oxygen may comprise up to 0.1%, 0.2%, 0.5%, 0.7%, 1%, 1.5%, 2%, 2.5%, 3%, or up to 4% of the gas concentration.

In some examples, causing the inert gas to flow is performed by a blower, pump, and/or a compressor in communication with the closed volume.

The closed volume may be a reactor vessel and guard vessel annulus (RV-GV annulus). In other cases, the closed volume may be a guarded pipe having an internal pipe and a guard pipe surrounding the internal pipe and the closed volume is a space between the internal pipe and the guard pipe.

The method may include the step of generating an alert associated with determining that sodium leak has occurred into the volume. The alert may be one or more of an audio and a visual alert. The alert may be message sent to a computing device, an alarm, a light, a warning, a klaxon, or some other type of audio or visual alert.

In some cases, the closed volume is segmented to create segmented volumes and the method may include determining the oxygen concentration in each of the segmented volumes. For instance, a dedicated recirculation loop, recirculator, and trace oxygen sensor may be provided for each of the segmented volumes which are then monitored for sodium leakage.

The foregoing and other features and advantages will become further apparent from the following Detailed Description, read in conjunction with the drawings.

### BRIEF DESCRIPTION OF THE DRAWINGS

FIG. 1 illustrates various components of a nuclear reactor, according to some embodiments.

FIG. 2 illustrates a graph showing how a concentration of O₂ changes in response to leaked sodium, in accordance with some embodiments.

FIG. 3 illustrates a system configured to detect a concentration of O₂ within an inert gas flowing through the RV-GV annulus, in accordance with some embodiments.

FIG. 4 illustrates guard piping utilizing a sodium leak detection system, in accordance with some embodiments.

FIG. 5 shows a process flow for detecting a sodium leak, in accordance with some embodiments.

### DETAILED DESCRIPTION

This disclosure generally relates to method and systems for detecting sodium leaks from a nuclear reactor vessel.

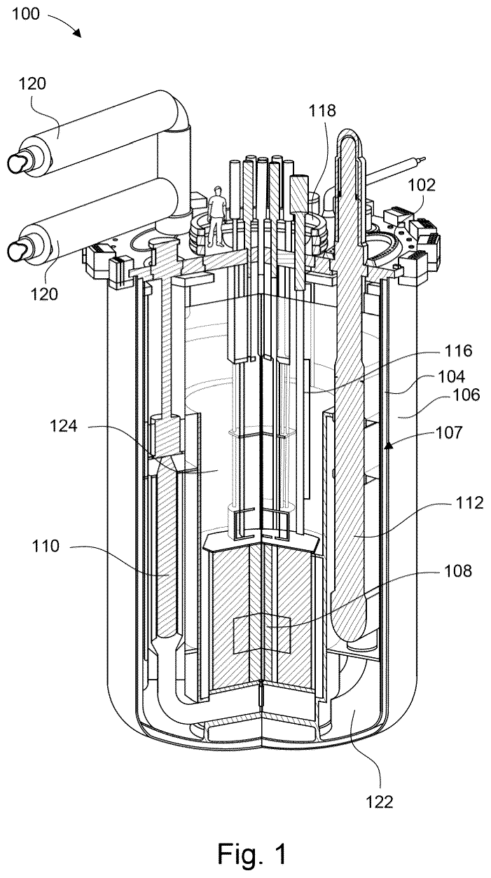

Referring to FIG. 1, many of the components and sub-assemblies of a nuclear reactor 100 are illustrated. For example, a reactor head 102, a reactor vessel 104 and guard vessel 106, but also illustrates many ancillary reactor components such as structural members, flanges, cover plates, piping, railing, framing, connecting rods, and supports. While the illustrated nuclear reactor 100 is a sodium fast reactor (SFR), it should be appreciated that the components and embodiments described herein could be applied to any suitable reactor configuration. For example, many of the systems, components, assemblies, and sub-assemblies described herein could be utilized in any reactor that utilizes core components that are inserted into, removed from, or shuffled within, the reactor core.

The nuclear reactor 100 is designed to hold a number of nuclear fuel pins (not shown) in a reactor core 108 located near the bottom of the reactor vessel 104. The reactor head 102 seals the radioactive materials within the reactor vessel 104 and guard vessel 106. In the embodiment shown the reactor core 108 can only be accessed through the reactor head 102. For example, an in-vessel fuel handling machine 116 is provided. The fuel handling machine 116 allows fuel pins and other core components and instruments to be lifted from the core 108 and removed from the reactor vessel 104 via a set of large and small rotating plugs 118 located in the reactor head 102. This design allows the reactor vessel 104 to be unitary and without any penetrations.

Sodium, which is a liquid at the nuclear reactor operating temperatures, is the primary coolant for removing heat from the reactor core 108. The reactor vessel 104 is filled to some level with sodium which is circulated through the reactor core 108 using pumps 110 and also by natural circulation. In some embodiments, two or more sodium pumps 110 are provided, which may be electromagnetic pumps. In some cases, one or more pumps 110 may include an impeller which may extend through the reactor head 102 to a motor located above the reactor head 102.

In some embodiments, the pumps 110 are configured to circulate the sodium through one or more intermediate heat exchangers 112 located within the reactor vessel 104. Sodium from the cold pool 122 is pumped up into the core 108 where it becomes heated from the nuclear fission reactions. The heated sodium travels up out of the core and into the hot pool 124. The sodium flows upwardly by natural circulation as heated sodium has a lower density than cold sodium in the cold pool, and also by forced pressure from the one or more pumps 110. The heated sodium in the hot pool is drawn into the intermediate heat exchangers 112 which transfer heat from the primary sodium coolant to a secondary coolant. Fresh secondary coolant is piped through the reactor head 102 via one or more heat transport loop pipes 120 to the intermediate heat exchangers 112 where it is heated. Heated secondary coolant then flows out of the reactor head 102 through the heat transport loop piping 120. In some embodiments, the heated secondary coolant is used to generate steam which transferred to a power generation system. The secondary coolant may be a sodium coolant or a salt coolant such as a sodium-potassium nitrate or some other suitable coolant.

In some cases, the reactor vessel 104 operates at temperatures between 350° C. and 550° C., with the primary sodium coolant 302 maintained at approximately 510° C. during normal operation. The cover gas pressure above the sodium pool is typically maintained at 0.1 to 0.5 psig, while the RV-GV annulus 107 pressure is maintained at 0.05 to 0.45 psig, creating a differential pressure of approximately 0.05 psig that ensures any leakage flows from the reactor vessel 104 into the annulus 107.

While the reactor vessel 104 is a sealed vessel that contains the sodium inventory, it is possible for the reactor vessel 104 to leak sodium, such as through a breach in the reactor vessel itself 104. There is a space between the reactor vessel 104 and the guard vessel 106, referred to as the reactor vessel-guard vessel annulus (RV-GV annulus) 107. This RV-GV annulus is a large volume, and may be on the order of 5,000 ft³ (141.58 m³). In many cases, the RV-GV annulus 107 is filled with an inert gas, which may be argon, for example. The inert gas within the RV-GV may be used to inhibit volatile reaction of any leaking sodium with oxygen or water.

In some cases, a sodium leak may be detected by recirculating the inert gas in the RV-GV annulus. The pressure of the primary cover gas may be higher than the pressure maintained in the RV-GV annulus, and may only be a small difference such as 0.01-0.1 psig. In some cases, the difference in pressure between the cover gas and the RV-GV annulus may be about 0.05 psig, such that any leakage in the cover gas space of the reactor vessel 104 will flow from the reactor vessel to the guard vessel 106. Similarly, any leakage below the pool level of primary sodium will have a sufficient static head to leak sodium into the RV-GV annulus 107.

By forcing any leaks to enter the RV-GV annulus, methods and systems may be employed to detect any leaks, even where the leaks are extremely small. For example, an inert gas circulated within the RV-GV annulus 107 may be doped with a small amount of oxygen, sufficient to oxidize with any leaked sodium, but insufficient to combust. The introduced oxygen may be controlled with minimal fluctuations in compositions to provide for a more efficient leak detection. The inert gas may be circulated throughout the RV-GV annulus 107 to ensure good coverage and reduced stagnant flow zones. The circulation may be provided by a recirculatory, which may include one or more pumps, fans, compressors, blowers, gas circulators, or some other type of device that can efficiently circulate gas throughout the RV-GV annulus 107. According to embodiments described herein, the leak detection systems and methods are highly sensitive, allowing a leak to be detected with a very small volume of sodium leaking.

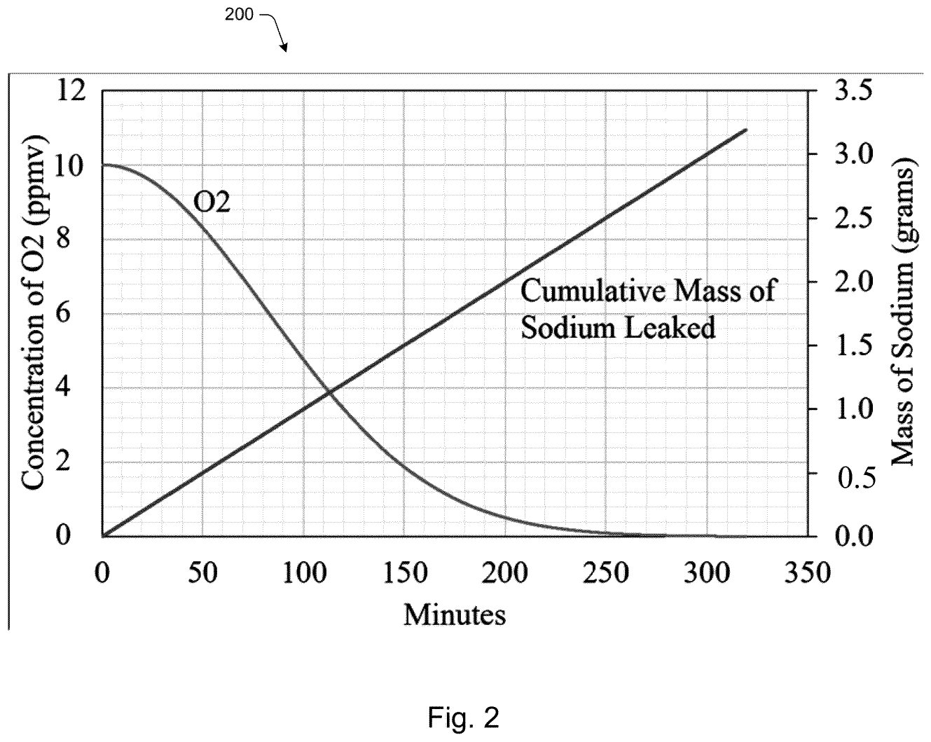

FIG. 2 illustrates a graph 200 showing how a concentration of O₂ changes in response to leaked sodium. As illustrated, an initial concentration of O₂ begins at 10 ppm within an inert atmosphere. As sodium begins to leak, it contacts the O₂ and quickly becomes consumed to form a series of oxides, such as those shown below:

$$x Na + {O}_{2} \to {aNa}_{2} O + b {Na}_{2} {O}_{2} + {c NaO}_{2} + ( 1 - \frac{a}{2} - 2 b - 2 c ) {O}_{2}$$

The line beginning at 0,0 indicates the cumulative mass of sodium leaked in order to consume all the available oxygen. As can be seen, it takes very little sodium to result in a drastic change in the concentration of O₂ in the inert gas. An oxygen sensor can be used to measure the concentration of O₂ in the inert gas, and because the inert gas may be circulated, the O₂ reacts quickly with the leaking sodium. In fact, a sodium leak on the order of grams, or mL can be detected. The described systems are very sensitive to small leaks and can be ascertained relatively quicky, especially when compared with traditional methods of sodium leak detection.

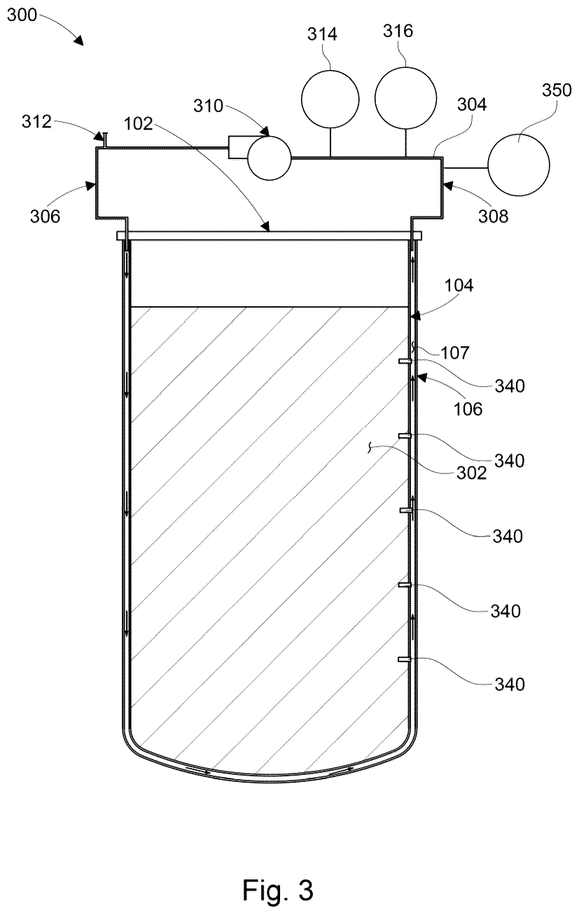

FIG. 3 illustrates a system 300 configured to detect a concentration of O₂ within an inert gas flowing through the RV-GV annulus 107. A reactor vessel 104 is surrounded by a guard vessel 106 and the combination of vessels define the RV-GV annulus 107 space therebetween. The reactor vessel 104 and the guard vessel 106 are closed at their respective top ends by a reactor head 102. The reactor vessel 104 is filled with a volume of primary sodium coolant 302. Above the level of the primary sodium coolant 302 is a volume that is filled with a cover gas, which may be an inert gas.

The RV-GV annulus 107 is a large volume, and in some cases is about 28 m³, or 57 m³, or 85 m³, or 113 m³, or 140 m³, or 170 m³, or larger. As such, it may not be feasible to detect sodium aerosols or to provide instruments all around the GV in order to detect sodium leakage. In such cases, the typical leak detection systems would only detect a sodium leak at a relatively high leak volume, such as greater than about 100 gallons, depending on the size of the reactor, and may require a leak of up to hundreds of gallons in order to detect the leak. According to embodiments described herein, systems and methods are highly sensitive and able to detect sodium leaks at low leak volumes, such as below about 2 L, or 1 L, or 0.5 L, or 0.02 L, or 0.01 L, 0.001 L, 0.00001 L, or even less.

According to some embodiments, a recirculation loop 304 may be provided that is in fluid communication with the RV-GV annulus 107. For instance, an inlet 306 provides a flow path into the RV-GV annulus. An inert gas with a trace amount of oxygen may be provided through the inlet 306 and circulates throughout the RV-GV annulus 107 and then exits the annulus at an outlet 308. The recirculation loop 304 may provide a closed fluid flow path through the recirculation loop 304 and the RV-GV annulus 107. The flow may be encouraged by one or more recirculation blowers 310 that cause the inert gas with trace oxygen to flow through the recirculation loop 304 and the RV-GV annulus 107. Of course, other devices may be used in addition to, or in place of, the recirculation blower. Other suitable devices may include a pump, a compressor, a fan, or a combination of these, or other devices. A supply pathway 312 for the introduction of the inert gas and the trace oxygen may be provided, and in some cases, is provided downstream of the recirculation blower 310 in order to encourage the inert gas and trace oxygen to be effectively circulated throughout the recirculation loop 304.

An oxygen sensor 314 may be provided along the recirculation loop 304 and can be configured to detect trace amounts of oxygen present within the inert gas flowing through the recirculation loop 304 and RV-GV annulus 107. In prior sodium leak detectors, if there were a sodium leak closer to the top of the reactor vessel, it would take a considerable amount of time for the leaking sodium to travel to the bottom of the RV-GV annulus 107 in order to reach the contact detectors located near the bottom of the RV-GV annulus 107. By the present system and methods, even a very small leak will cause sodium to evaporate and create sodium vapor which reacts with the trace oxygen flowing through the recirculation loop. The oxygen sensor 314 is configured to detect trace amounts of oxygen, and any reduction in the concentration of oxygen will indicate a sodium leak. Moreover, the time it may take to detect the leak is on the order of minutes, or even hours, as opposed to prior methods which may never detect the leak, or if they did, could take days or weeks.

In some cases, the inert gas and trace oxygen mixture has a variable flow rate, such as by controlling the recirculation blower 310 so the mixing within the RV-GV annulus 107 is increased and the flow rate through the recirculation loop 304 is increased. This may lead to leaks, even very minor leaks, to be detected much faster than previous methods. Furthermore, the rate of reduction of the oxygen levels in the inert gas may be used to indicate the size of the sodium leak. For instance, if a small volume of sodium leaks, the oxygen concentration may reduce gradually over time. However, with a larger sodium leak, the entire volume of oxygen may react very quickly and the change in oxygen concentration detected by the trace oxygen sensor 314 may approach a step function drop off in concentration. In some cases, the recirculation blower 310 is operated to cause 5, 10, 20, 30, 50, or greater cubic foot per minute (CFM) volumetric flow of the inert gas through the recirculation loop 304.

In some cases, the recirculation loop 304 forms a closed system with the RV-GV annulus 107 so the inert gas with trace oxygen remains circulating throughout the RV-GV annulus. With a known concentration of oxygen, which may be as low as 1 ppm, or 5 ppm, or 10 ppm, or 20 ppm, or 50 ppm, or 100 ppm. In some cases, the concentration of oxygen is between 1 ppm and 1% of the inert gas volume. The trace oxygen sensor 314 may be operated continuously and any reduction in the oxygen concentration can be indicative of a sodium leak from the reactor vessel 104 into the RV-GV annulus 107.

While most traditional leak detection system rely on the transport of sodium to indicate a leak, the presently disclosed systems and methods do not rely on sodium transport, but rather, can rely on either liquid sodium or sodium vapor that quickly reacts with the trace oxygen provided in the inert gas to indicate a leak.

In some cases, nitrogen could be used as the inert gas. While nitrogen may have a tendency to embrittle steel components, a small amount of oxygen mixed in with the nitrogen will reduce the embrittlement effects.

According to some implementation methods, the recirculation loop 304 and RV-GV annulus 107 is filled with an inert gas (e.g., argon). A trace amount of oxygen can be inserted, such as through the oxygen supply 312. A known volume of oxygen can be added, and the trace oxygen sensor 314 can be used to verify that the desired concentration of oxygen and argon has been achieved. In some cases, the desired concentration is on the order of 10 ppm. By flowing the inert gas and trace oxygen through a closed vessel, there are a fixed number of mols of oxygen that are circulating throughout the space. By monitoring the trace oxygen sensor 314, as the oxygen levels begin to decrease, the system may provide an indication of a sodium leak. The indication may be a message, a sound, a visual indicator, or some other indicia of the reduction in oxygen concentration.

In some cases, the inlet 306 is provided as a plenum that extends down into the RV-GV annulus 107 and may include a plurality of apertures for flowing the inert gas and trace oxygen through the RV-GV annulus 107. The plurality of apertures may be formed to have different sizes in order to encourage mixing and flow of the inert gas through the RV-GV annulus. The plurality of apertures may be formed as one or more nozzles configured to inject the inert gas into the RV-GV annulus and encourage mixing and flow through the RV-GV annulus 107 and the recirculation loop 304.

The recirculation loop 304 may include a plurality of injection nozzles 340 strategically distributed throughout the RV-GV annulus 107 to promote gas circulation and minimize stagnant zones. The injection nozzles 340 may be arranged at multiple vertical elevations, such as at heights of 25%, 50%, 75%, and 90% of the total annulus height, with each elevation containing between 4 and 12 nozzles spaced circumferentially around the annulus. In some cases, the nozzles 340 are oriented at an angle between 30° and 60° relative to the radial direction, preferably about 45°, to impart a tangential velocity component to the injected gas. This angular orientation creates a helical or swirling flow pattern 342 within the annulus, promoting vertical mixing while maintaining circumferential flow. The swirling pattern ensures that gas from the bottom of the annulus is continuously exchanged with gas at higher elevations, thereby reducing the response time for detecting leaks at any vertical location. The nozzles 340 may have varying orifice diameters, with larger diameters at lower elevations where natural convection is weaker, and smaller diameters at upper elevations where buoyancy effects assist circulation. Adjacent vertical levels may have their nozzles oriented to create counter-rotating swirl patterns, further enhancing mixing through flow impingement and turbulence generation. The total flow through all nozzles may be balanced to achieve between 5 and 20 complete annulus volume changes per hour while maintaining the desired pressure differential between the reactor vessel cover gas and the RV-GV annulus.

In combination with the trace oxygen sensor 314, a radiation detector 316 can also be disposed along the recirculation loop 304 to measure radioactivity of the inert gas. For instance, in the presence of a sodium leak from the reactor vessel 104, the inert gas flowing in the RV-GV annulus 107 will become activated by the leaking sodium. This radioactivity can be detected by the radiation detector 316, and will thus also indicate a sodium leak from the reactor vessel. The radiation detector 316 is quite sensitive and even a small sodium leak will cause an increase in the radioactivity of the inert gas, which can be measured and trigger an alert or indicia that a sodium leak has been detected.

### Leak Rate Determination and Quantification

In some cases, the system continuously calculates the leaked sodium mass based on oxygen depletion using the stoichiometric relationship: 4Na+O₂→2Na₂O

From this reaction, 2.87 grams of sodium consumes 1 gram of oxygen. The data acquisition system 330 samples the oxygen concentration at intervals of 1 to 60 seconds and calculates: Leaked Sodium Mass=(ΔO₂×V×ρ×2.87)/RT, where ΔO₂ is the change in oxygen concentration (ppm), V is the annulus volume (m³), ρ is the oxygen density at operating conditions, R is the gas constant, and T is absolute temperature.

The system can detect sodium leaks as small as 0.001 grams (approximately 0.001 mL) within 5 minutes of leak initiation for a 10 ppm initial oxygen concentration in a 140 m³ annulus volume. In some embodiment, the leak rate can be determined such as by monitoring the rate of oxygen concentration reduction, and one or more graduated alerts may be generated based upon the determined sodium leak rate. For instance, a small leak may result in a first alert, while a larger leak may result in a second alert indicating a higher priority than the first alert. This may based on a volume of the alert, may be an audible warning having different pitches or voice announcements, or a message or flashing lights having various intensities, or other suitable alerts indicating higher leak rates.

As an example of oxygen depletion in the inert gas, with an example 5 ppm of oxygen in the inert gas and RV-GV volume of inert gas of about 5,000 ft3 (141 m³), this equates to 2.5×10-2 ft³ (7.08×10−4 m³) of oxygen. Using an oxygen density of 0.49794 kg/m3 (1 atm and 510° C.), this is 3.53×10-4 kg of O₂ in the RV-GV annulus. Relating the chemical equation for sodium oxide (4Na+O2→2Na2O, 4Na=91.96 g/mol O2=32 g/mol, 91.96/32=2.87), 2.87 kg of sodium would be consumed by every 1 kg of oxygen, so 1.01 g of sodium (3.53×10−4 kg O2×2.87=1.01×10−3 kg) of sodium would theoretically consume the oxygen in the RV-GV annulus. The described trace oxygen sensors can detect±0.2 ppm O₂, which would be equivalent to 0.05 mL of sodium if using the estimated volume of the RV-GV.

The sodium leak detection system may include a graduated alert system that provides differentiated responses based on leak severity and rate of oxygen depletion. In some examples, the graduated alert system 350 monitors the rate of change of oxygen concentration (dO₂/dt) and categorizes leak events into multiple severity levels. A Level 1 (low) alert is triggered when oxygen concentration decreases by 0.5 to 2 ppm over a 10-minute period, indicating a minor leak typically less than 0.1 mL/min. This alert may generate a yellow visual indicator on the control panel and log the event without requiring immediate operator action. A Level 2 (medium) alert may activate, such as when oxygen depletion exceeds 2 ppm but remains below 5 ppm over 10 minutes, suggesting leak rates between 0.1 and 1.0 mL/min. Level 2 alerts may trigger amber warning lights, audible alarms such as at about 70 dB for example, automated notifications to control room operators, and may initiate enhanced monitoring protocols. A Level 3 (high) alert may occur when oxygen concentration drops more than 5 ppm within 10 minutes or falls below 20% of the initial concentration, indicating leak rates exceeding 1.0 mL/min. Level 3 alerts may activate red strobe lights, loud (e.g., ≥85 dB) klaxons, immediate automated notifications to plant management and safety personnel, and may trigger automatic reactor power reduction or shutdown sequences. The system may also includes a Level 4 (critical) alert for catastrophic leaks, such as where oxygen depletion exceeds 90% within 60 seconds, automatically initiating emergency response protocols. Each alert level may have configurable setpoints and time delays to prevent spurious alarms while ensuring rapid response to genuine leak events. The graduated alert system 350 may interface with the plant's distributed control system (DCS) to log all events with timestamps, oxygen concentration trends, calculated leak rates, and estimated total leaked sodium volume, providing operators with comprehensive information for informed decision-making.

In addition to detecting sodium leaks from the reactor vessel 104 into the RV-GV annulus 107, the described systems and methods may also be used to detect sodium leaks in piping assemblies or other easily oxidated fluids, where an inert gas with doped oxygen is passed between an inner pipe and a guard pipe.

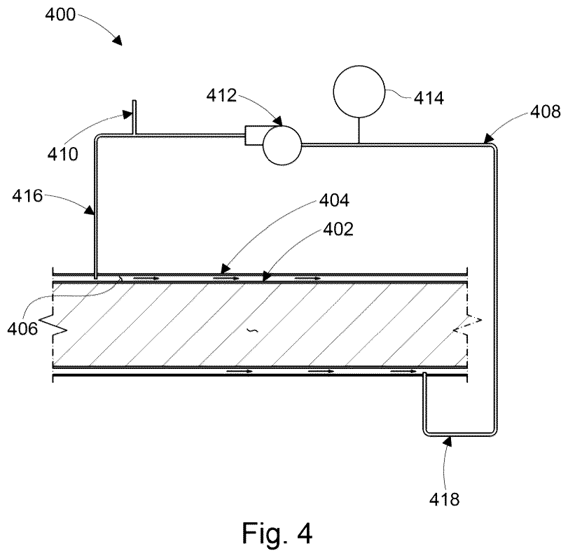

FIG. 4 illustrates guard piping 400 that uses the systems and methods described herein for leak detection. An inner pipe 402 is surrounded by a guard pipe 404, thus creating an annulus 406 between the inner pipe 402 and the guard pipe 404. A recirculation loop 408 can be in fluid communication with the annulus 406. An oxygen supply 410 can be used to add oxygen and/or inert gas to the recirculation loop 408 to provide a known volume of oxygen to the closed system. A recirculation blower 412 may be provided to force the inert gas with trace oxygen through the recirculation loop 408. A trace oxygen sensor 414 may be in communication with the recirculation loop 408 to detect a quantity and/or a concentration of oxygen in the inert gas. The recirculation loop 408 may be in communication with the annulus 406 at an inlet 416 and an outlet 418, which may include fittings or couplings to allow the recirculation loop 408 to fluidically communicate with the annulus 406.

As liquid sodium flows through the inner pipe 402, any leaks of the inner pipe will cause sodium to enter the annulus 406 where it reacts with the trace oxygen within the inert gas flowing therethrough. As the inert gas flows through the recirculation loop 408, the trace oxygen sensor 414 will detect any reduction in the concentration of oxygen in the inert gas, thus signifying a leak of sodium from the inner pipe 402.

Any of a number of alerts or indicia may be provided to indicate a sodium leak. For example, a light, a message, an alarm, a visual indicator, and audio indicator, an electronic message may be sent, or some other alert that the trace oxygen sensor 414 has detected a reduction in the oxygen concentration, which signifies a sodium leak from the inner pipe 402 into the annulus 406.

As with any of the embodiments described herein, the oxygen sensor can be any suitable sensor. The trace oxygen sensor is designed to detected very low levels of oxygen, often in the single-digit parts per million range, or even in the parts per billion (ppb) range. Suitable sensors may include electrochemical sensors, zirconia sensors, optical sensors, or other sensor types.

An electrochemical sensor includes a sensing electrode (e.g., cathode), a counter electrode (e.g., anode), and an electrolyte. When oxygen diffuses through a gas-permeable membrane and reaches the cathode, it gets reduced (i.e., gains electrons). This reduction reaction generates a current proportional to the amount of oxygen present, and the reaction is typically:

$${O}_{2} + {4 H}^{+} + 4 {e}^{-} \to 2 {H}_{2} O$$

Electrochemical sensors are very sensitive and can detect oxygen levels down to low ppm or even ppb ranges with a fast response time, usually measured in a few seconds or minutes.

Zirconia sensors (e.g., zirconium dioxide) operate at high temperatures and use a solid electrolyte made of zirconium dioxide stabilized with yttria. When heated, zirconia becomes conductive to oxygen ions. The sensor typically consists of two electrodes with a zirconia electrolyte in between. One side is exposed to the sample gas and the other to a reference gas. The difference in oxygen concentration across the electrodes generates a voltage that is proportional to the logarithm of the ratio of the oxygen partial pressures.

Optical oxygen sensors may use a fluorescence-quenching principle. A luminescent dye is excited by a light source, and the presence of oxygen quenches the luminescence, reducing the intensity of emitted light. The decrease in luminescence is proportional to the oxygen concentration, which can be effectively measure by a photo detector. Optical sensors are highly sensitive and are capable of detecting oxygen in the ppb range, while offering fast response times and can be used in harsh environments and inert gas atmospheres.

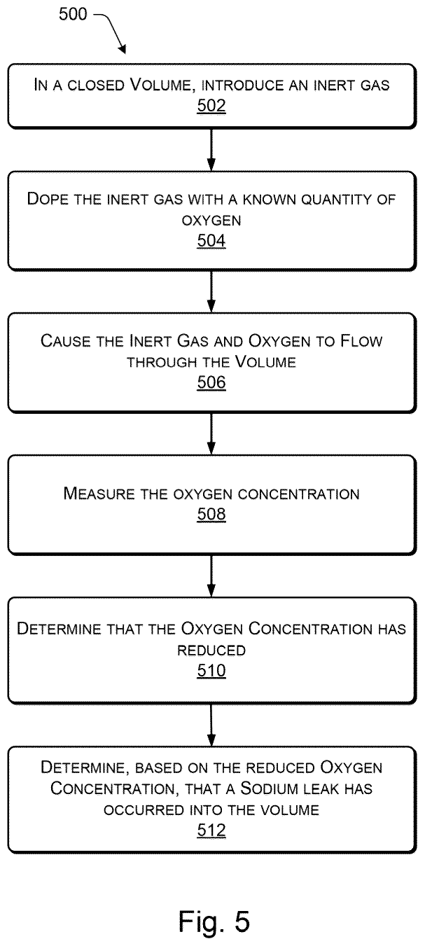

FIG. 5 illustrates a method for determining leaking sodium 500. At block 502, an inert gas is introduced into a closed volume. In some cases, the closed volume is a RV-GV annulus, an annulus between an inner pipe and a guard pipe, or some other closed volume. At block 504, the inert gas is doped with a known quantity of oxygen. This may be done before the inert gas is introduced into the closed volume, or may be done as a separate step after the inert gas has been introduced to the system. The oxygen may be added until a desired concentration of oxygen is stabilized in the closed system of inert gas. In some cases, oxygen is introduced until it reaches a desirable ppm, such as 1, 5, 10, 15, or 20 ppm. In other cases, oxygen may be introduced until a desired percentage of oxygen is reached, such as 0.1%, 0.5%, or up to 1%, for example. In many cases, the oxygen concentration is purposefully kept below a combustion threshold.

At block 506, the inert gas with doped oxygen is caused to flow through the volume. This may be done, for example, by a blower, a fan, a pump, a compressor, or some other suitable method. Force flowing the inert gas aids in mixing the oxygen and driving the gas through the closed volume and to the oxygen sensor.

At block 508, the oxygen concentration is measured, such as by any suitable trace oxygen sensor. Once the initial doping of oxygen is added and mixed with the inert gas, the oxygen concentration remains stable until the system experiences a change that reduces the oxygen, such as a chemical reaction.

At block 510, the oxygen concentration has reduced. The oxygen sensor may continuously, or periodically, sample the inert gas and determine the oxygen concentration. In the presence of sodium, for example, the oxygen will react, and the sensor will show a decrease in the oxygen levels and/or the oxygen concentration in the inert gas.

At block 512, the system can determine, based on the reduced oxygen concentration, that a sodium leak has occurred into the volume, thus reducing the oxygen level.

The system may then output an alert, an indicia, a message, or some other notification associated with the decrease in oxygen and the leak can be further investigated. Thus, the systems and methods described herein provide an early warning system of a sodium leak. The severity of the leak may partially be determined, for instance, by the speed at which the oxygen concentration reduces to zero. However, one of the purposes of the described systems is to identify a leak so that remediation can begin, such as by determining the location of the leak and repairs can be made.

In some cases, the closed volumes, such as the RV-GV annulus, or the guarded pipe annulus, may be segmented into smaller volumes, each having a dedicated recirculation loop, and each of the smaller volumes may be watched for leaks within the segmented volume. Therefore, in some cases, one of the optional steps in the method is to segment a closed volume into smaller volumes and install a recirculation loop with trace oxygen sensor for each segmented volume. This not only encourages a leak to be detected sooner because of the smaller volume, but also aids in identifying the location of the sodium leak.

The foregoing description of specific embodiments will so fully reveal the general nature of embodiments of the disclosure that others can, by applying knowledge of those of ordinary skill in the art, readily modify and/or adapt for various applications such specific embodiments, without undue experimentation, without departing from the general concept of embodiments of the disclosure. Therefore, such adaptation and modifications are intended to be within the meaning and range of equivalents of the disclosed embodiments, based on the teaching and guidance presented herein. The phrascology or terminology herein is for the purpose of description and not of limitation, such that the terminology or phraseology of the specification is to be interpreted by persons of ordinary skill in the relevant art in light of the teachings and guidance presented herein.

The breadth and scope of embodiments of the disclosure should not be limited by any of the above-described example embodiments but should be defined only in accordance with the following claims and their equivalents.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

Throughout the instant specification, the term “substantially” in reference to a given parameter, property, or condition may mean and include to a degree that one of ordinary skill in the art would understand that the given parameter, property, or condition is met with a small degree of variance, such as within acceptable manufacturing tolerances. By way of example, depending on the particular parameter, property, or condition that is substantially met, the parameter, property, or condition may be at least approximately 90% met, at least approximately 95% met, or even at least approximately 99% met.

As used herein, the terms “about” and “approximately” may, in some examples, indicate a variability of up to ±5% of an associated numerical value, e.g., a variability of up to ±2%, or up to ±1%.

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

It is, of course, not possible to describe every conceivable combination of elements and/or methods for purposes of describing the various features of the disclosure, but those of ordinary skill in the art recognize that many further combinations and permutations of the disclosed features are possible. Accordingly, various modifications may be made to the disclosure without departing from the scope or spirit thereof. Further, other embodiments of the disclosure may be apparent from consideration of the specification and annexed drawings, and practice of disclosed embodiments as presented herein. Examples put forward in the specification and annexed drawings should be considered, in all respects, as illustrative and not restrictive. Although specific terms are employed herein, they are used in a generic and descriptive sense only, and not used for purposes of limitation.

Unless otherwise noted, the terms “a” or “an,” as used in the specification, are to be construed as meaning “at least one of.” Finally, for ease of use, the terms “including” and “having” (and their derivatives), as used in the specification, are interchangeable with and have the same meaning as the word “comprising.”

From the foregoing, and the accompanying drawings, it will be appreciated that, although specific implementations have been described herein for purposes of illustration, various modifications may be made without deviating from the spirit and scope of the appended claims and the elements recited therein. In addition, while certain aspects are presented below in certain claim forms, the inventors contemplate the various aspects in any available claim form. For example, while only some aspects may currently be recited as being embodied in a particular configuration, other aspects may likewise be so embodied. Various modifications and changes may be made as would be obvious to a person skilled in the art having the benefit of this disclosure. It is intended to embrace all such modifications and changes and, accordingly, the above description is to be regarded in an illustrative rather than a restrictive sense.

What is claimed is:

1. A sodium leak detection system for a nuclear reactor, comprising:
a recirculation loop in fluid communication with a reactor vessel-guard vessel annulus (RV-GV annulus);
an inert gas within the recirculation loop and RV-GV annulus;
a recirculator in communication with the recirculation loop and configured to flow the inert gas through the recirculation loop and RV-GV annulus;
a source of oxygen configured to introduce a predetermined amount of oxygen into the inert gas; and
a trace oxygen sensor disposed to detect an oxygen concentration within the inert gas.

2. The sodium leak detection system as in claim 1, further comprising a radiation detector in communication with the recirculation loop and configured to determine a radioactivity level of the inert gas within the recirculation loop.

3. The sodium leak detection system as in claim 1, wherein the recirculator is one or more of a blower, fan, pump, or compressor.

4. The sodium leak detection system as in claim 1, wherein the RV-GV annulus is a space between a reactor vessel and a guard vessel and wherein the reactor vessel includes an inventory of liquid sodium.

5. The sodium leak detection system as in claim 4, further comprising a cover gas area disposed inside the reactor vessel and above the inventory of liquid sodium, and
wherein a first pressure in the cover gas area is greater than a second pressure within the RV-GV annulus.

6. The sodium leak detection system as in claim 1, wherein the recirculation loop comprises one or more nozzles for injecting the inert gas into the RV-GV annulus.

7. The sodium leak detection system as in claim 1, further comprising a data acquisition system configured to:
monitor the oxygen concentration;
determine an oxygen depletion rate; and
determine a sodium leak rate based on the oxygen depletion rate.

8. The sodium leak detection system as in claim 7, wherein the data acquisition system is further configured to generate an alert when the oxygen concentration decreases by more than 0.5 ppm.

9. The sodium leak detection system as in claim 1, wherein the recirculation loop comprises a plurality of injection nozzles distributed at different vertical heights within the RV-GV annulus.

10. The sodium leak detection system as in claim 9, wherein the injection nozzles are oriented to create a swirling flow pattern within the RV-GV annulus.

11. A method of detecting a sodium leak, comprising:
introducing an inert gas into a closed volume;
doping the inert gas with a known quantity of oxygen;
causing the inert gas and oxygen to flow through the closed volume;
measuring an oxygen concentration in the inert gas;
determining, with a trace oxygen sensor, that the oxygen concentration has reduced; and
determining, based at least in part on the reduced oxygen concentration, that a sodium leak has occurred into the volume.

12. The method of claim 11, further comprising measuring a radioactivity of the inert gas and determining that a sodium leak has occurred based at least in part on an increased radioactivity of the inert gas.

13. The method of claim 11, wherein the known quantity of oxygen is less than 15 parts per million (ppm).

14. The method of claim 11, wherein causing the inert gas to flow is performed by one or more of a blower, pump, and a compressor in communication with the closed volume.

15. The method of claim 11, wherein the closed volume is a reactor vessel and guard vessel annulus (RV-GV annulus).

16. The method of claim 11, wherein the closed volume is a guarded pipe having an internal pipe and a guard pipe surrounding the internal pipe and the closed volume is a space between the internal pipe and the guard pipe.

17. The method of claim 11, further comprising generating an alert associated with determining that sodium leak has occurred into the volume.

18. The method of claim 17, wherein the alert includes one or more of an audio and a visual alert.

19. The method of claim 11, further comprising segmenting the closed volume to create segmented volumes and determining the oxygen concentration in each of the segmented volumes.

20. The method of claim 11, further comprising:
calculating a rate of oxygen concentration reduction;
determining a sodium leak rate based on the rate of oxygen concentration reduction; and
generating a graduated alert based on the determined sodium leak rate.
